(19) United States
(12) Patent Application Publication
(10) Pub. No.: US 2009/0196132 A1
(43) Pub. Date: Aug. 6, 2009

(54) Method for Improving Focus Accuracy of an Optical Pickup Head

(75) Inventor: Tao-Yen Wei, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 12/357,502

(22) Filed: Jan. 22, 2009

(30) Foreign Application Priority Data
Feb. 4, 2008 (CN) 200810005754.0

(51) Int. Cl. G11B 7/00

(52) U.S. Cl. 369/44.17; G9B/7

(57) ABSTRACT

The present invention discloses a method used in an optical disk drive for improving focus accuracy of an optical pickup head. Firstly, during each one revolution of the optical disk, RFᵢₙᵢₜᵢₐₗ, RF_{first} and RF_{second} are calculated respectively when the optical disk drive are driven by FOO_{initial′}, FOO_{first} and FOO_{second} respectively. Then, an optimal FOO signal is acquired according to the comparison of RFᵢₙᵢₜᵢₐₗ, RF_{first} and RF_{second}.

### FIELD OF THE INVENTION

The present invention relates to a method for improving focus accuracy of an optical pickup head, and more particularly to a method for improving focus accuracy of an optical pickup head which may write LightScribe discs.

### BACKGROUND OF THE INVENTION

Users who usually backup their data with optical discs may not know the backup data of optical discs by monotonic label side of optical discs which has no patterns. The conventional way to state the content of optical discs is to use marker pens writing on the label side of optical discs directly or to use printers printing label stickers for sticking on the optical discs. However, the unbalance weight distribution of the label stickers may cause that optical discs are not rotated smoothly when they are read. Or if the label stickers don't stick firmly on the back side of optical discs, the label stickers may fall off and cause the optical disc drive to jam and operate badly.

Therefore, presently some optical disc drive manufacturers provide a LightScribe technology. The LightScribe technology prints letters and pictures on the back side (the label side) of the optical disc which has a particular dye layer, i.e. the LightScribe disc. After the data is backup on the data side of the LightScribe disc, the LightScribe disc is turned over and placed back to the optical disc drive so that the label side of the LightScribe disc faced with the optical pickup head of the optical disc drive. The laser beam emitted from the optical pickup head penetrates the particular dye layer which is spread over the label side so that a chemical reaction is generated on the particular dye layer and thus patterns designed by users are printed on the label side.

Refer to FIG. 1A, which illustrates a label side of a particular disc 10, a LightScribe disc for example. The label side of the particular disc 10 consists of a control feature zone 11 and a label zone 12 which is a zone for printing letters or pictures. However, the label zone 12 lacks groove structures of the data side which are used for data recording, a number of spokes 13 as shown in FIG. 1B are set up in the inner ring of the particular disc 10, i.e. the inner part of the control feature zone 11. These spokes 13 are equally distributed on the inner side of the control feature zone 11. In the same time, a spoke decoding device is set in the optical disc drive which supports LightScribe technology thereby the optical disc drive may control the rotational position of the particular disc 10 by decoding every spoke 13. In addition, the optical pickup head is moved along the radial direction of the particular disc 10 by a stepping motor. Therefore, the optical pickup head which proceeds printing on the label zone 12 locates the relative position by the spoke decoding device and the stepping motor.

Presently the prior art proceeds focus control on the label side of the particular disc 10 with open loop control. In comparison to the signal wherein the optical disc drive reads/writes the data side, the signal wherein the optical disc drive reads/writes the label side is weaker. Therefore, the open loop control is adopted when the optical pickup head focuses on the label side. The optical pickup head firstly emits a laser beam on the label side, the optical disc drive thereby adjusts the focus position of the lens of the optical pickup head by a focus error signal which is acquired according to the reflected condition of the laser beam. In addition, the open loop control suggested by the LightScribe specification corrects the focus error only by the first order Fourier coefficient to fifth order Fourier coefficient, i.e. DC, Sin θ, Cos θ, Sin 2θ, and Cos 2θ. Hence, the control chip of the optical disc drive which supports LightScribe technology are designed so that FOO which is the voltage signal for driving lens, i.e. the signal for adjusting the focus position of the lens, is as below:

FOO=A1*DC+A2*Sin θ+A3*Cos θ+A4*Sin 2θ+A5*Cos 2θ

wherein the parameters A1, A2, A3, A4 and A5 are adjusted based on experiences of the optical disc drive manufacturers. So optical disc drive manufacturers may only adjust the focus position of the lens by adjusting the A1 to A5 parameters.

A phenomenon of NRRO (Non-Repeatable Run Out) occurs frequently in the spindle motor of the optical disc drive. That is to say, when the optical disc drive operates, the spindle motor for rotating the optical disc self-vibrates so that non-repeatable run out occurs to the optical disc. The phenomenon of NRRO usually causes that the optical disc vibrates at the frequency which are over two times of the rotating frequency of the optical disc in the perpendicular direction and also the vibration of the optical disc is over 100 μm. Under the above condition, the optical pickup head of the optical disc drive may not focus accurately which results in a bad printing quality of the LightScribe disc. The bad effect does more greatly on slim type optical disc drives.

The open loop control provided by the control chip can only correct the vibration which is below frequency of 2θ. However, the vibration of the optical disc drive resulted from the phenomenon of NRRO sometimes has frequency which is higher than 2θ, or sometimes the unexpected vibration also has frequency which is higher than 2θ. Hence the open loop control provided by the control chip can not eliminate the error resulted from the phenomenon of NRRO, the printing quality of the LightScribe discs is thus bad. Therefore, how to improve focus accuracy of the optical pickup head and printing quality of the LightScribe discs is the subject matter of the present invention.

### SUMMARY OF THE INVENTION

It is an object of the present invention to provide a firmware solution for effectively overcoming the problem of focus loss resulted from NRRO phenomenon of spindle motors.

In order to attain the foregoing object, a claimed invention provides a method for improving focus accuracy of an optical pickup head. Firstly, the optical disc is rotated a revolution and a corresponding initial disc signal is calculated when the optical disc drive is driven by an initial lens drive signal during the revolution of the optical disc. Then, a corresponding first disc signal and a corresponding second disc signal are calculated respectively when the optical disc drive is driven respectively by a first lens drive signal and a second lens drive signal during a revolution of the optical disc. At last an optimal lens drive signal is obtained according the initial disc signal, the first disc signal and the second disc signal.

According to the claimed invention, the first lens drive signal is the summation of the initial lens drive signal and a first voltage and the first lens drive signal drives the lens moving near the optical disc.

According to the claimed invention, the second lens drive signal is the summation of the initial lens drive signal and a second voltage and the second lens drive signal drives the lens moving away from the optical disc.

### BRIEF DESCRIPTION OF THE DRAWINGS

The above contents of the present invention will become more readily apparent to those ordinarily skilled in the art after reviewing the following detailed description and accompanying drawings, in which:

FIG. 1A is a diagram illustrating a label side of a particular disc.

FIG. 1B is a diagram illustrating spokes in the control feature zone.

FIG. 2 is a flow chart illustrating a method for improving focus accuracy of an optical pickup head.

FIG. 3 is a diagram illustrating a relationship between the lens drive signal and corresponding disc signal.

FIG. 4 is a flow chart illustrating another method for improving focus accuracy according to another embodiment of the present invention.

FIG. 5A is a diagram illustrating the printing result of the LightScribe disc before adopting the present invention.

FIG. 5B is a diagram illustrating the printing result of the LightScribe disc after adopting the present invention.

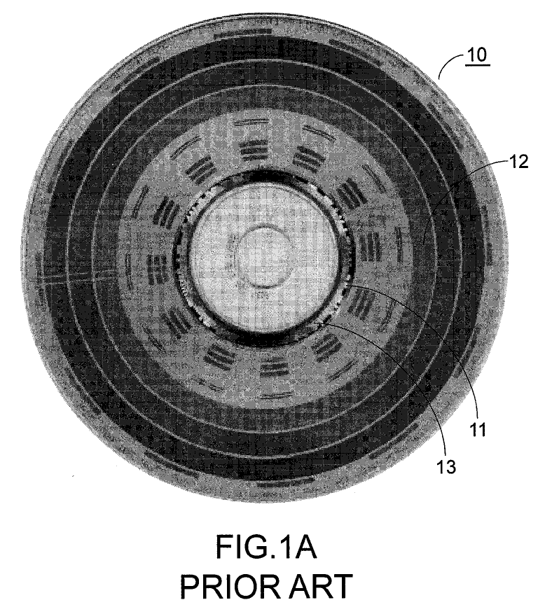

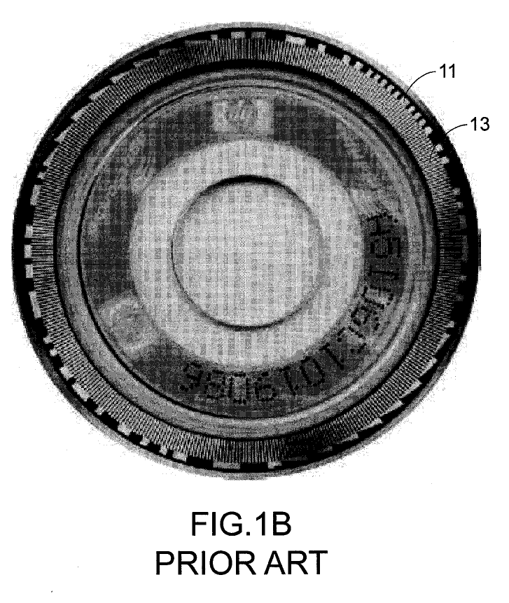

### DETAILED DESCRIPTION OF THE PREFERRED EMBODIMENT

In LightScribe technology, focus accuracy of the optical pickup head is a very important subject, because focus accuracy affects the follow-up printing quality of the LightScribe discs a lot. To improve the above problem, a method for improving focus accuracy of the optical pickup head is provided.

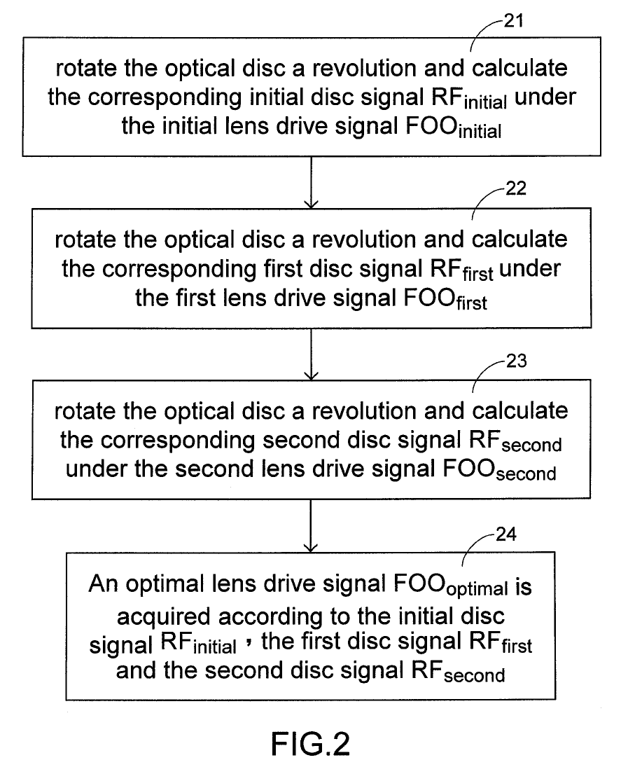

Refer to FIG. 2, which illustrates a flow chart of a method for improving focus accuracy of an optical pickup head.

Firstly, step 21 is proceeded: rotate the optical disc a revolution and calculate the corresponding initial disc signal RFᵢₙᵢₜᵢₐₗ under the initial lens drive signal FOOᵢₙᵢₜᵢₐₗ.

As mentioned in the prior art, the label side of the LightScribe disc comprises a control feature zone 11 and a label zone 12. About 400 spokes 13 are set up in the inner ring of the LightScribe disc, i.e. the inner part of the control feature zone 11. These spokes are equally distributed on the inner side of the control feature zone 11. Thus when the optical disc is rotated a revolution, about 400 spokes are read by the optical pickup head. The firmware then is designed that when the optical pickup head reads a spoke, an external interrupt command is issued.

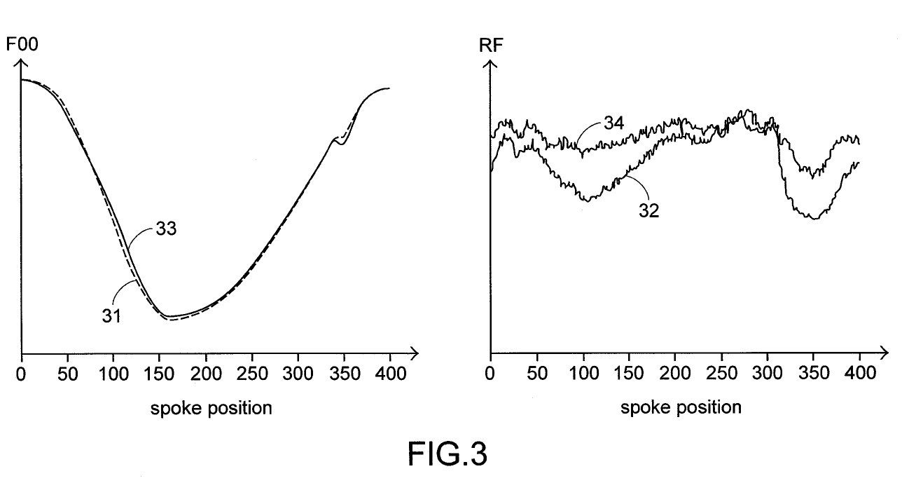

Moreover, the control chip of the optical disc drive mentioned in the prior art corrects the lens drive signal FOO by the first order Fourier coefficients to the fifth order Fourier coefficients. The initial lens drive signal FOOᵢₙᵢₜᵢₐₗ in step 21 is acquired by defining parameters A1 to A5 by experiences. The optical pickup head moves the focus position according to the received initial lens drive signal FOOᵢₙᵢₜᵢₐₗ. After the optical disc is rotated a revolution, there are 400 interrupt commands issued because the optical pickup head reads 400 spokes. The initial disc signal RFᵢₙᵢₜᵢₐₗ is calculated and recorded when the 400 interrupt commands are issued. The corresponding initial disc signal RFᵢₙᵢₜᵢₐₗ 32 under the initial lens drive signal FOOᵢₙᵢₜᵢₐₗ 31 are then shown in FIG. 3.

Afterwards, Step 22 is proceeded: rotate the optical disc a revolution and calculate the corresponding first disc signal RF_{first} under the first lens drive signal FOO_{first}.

The first lens drive signal FOO_{first} in step 22 is the summation of the first lens drive signal FOOᵢₙᵢₜᵢₐₗ and a first voltage. The first lens drive signal FOO_{first} drives the lens moving near the optical disc, i.e. the focus point emitted by the optical pickup head shifts near the optical disc. The optical pickup head moves the focus position according to the received first lens drive signal FOO_{first}. After the optical disc is rotated a revolution, there are 400 interrupt commands issued because the optical pickup head reads 400 spokes. The first disc signal RF_{first} is calculated and recorded when the 400 interrupt commands are issued.

Then, Step 23 is proceeded: rotate the optical disc a revolution and calculate the corresponding second disc signal RF_{second} under the second lens drive signal FOO_{second}.

The second lens drive signal FOO_{second} in step 23 is the summation of the initial lens drive signal FOOᵢₙᵢₜᵢₐₗ and a second voltage. The second lens drive signal FOO_{second} drives the lens moving away from the optical disc, i.e. the focus point emitted by the optical pickup head shifts away from the optical disc. The optical pickup head moves the focus position according to the received second lens drive signal FOO_{second}. After the optical disc is rotated a revolution, there are 400 interrupt commands issued because the optical pickup head reads 400 spokes. The second disc signal RF_{second} is calculated and recorded when the 400 interrupt commands are issued.

At last, Step 24 is proceeded: An optimal lens drive signal FOOₒₚₜᵢₘₐₗ is acquired according to the initial disc signal RFᵢₙᵢₜᵢₐₗ, the first disc signal RF_{first} and the second disc signal RF_{second}.

When 400 interrupt commands are issued, i.e. during each one revolution of the optical disc, RFᵢₙᵢₜᵢₐₗ, RF_{first} and RF_{second} are calculated respectively when the optical pickup head is driven by FOO_{initial′}, FOO_{first} and FOO_{second} respectively in step 21, 22 and 23. Thus the above three disc signals can be compared when every interrupt command is issued, i.e. when every spoke is read by the optical pickup head, the corresponding lens drive signal which has better disc signal are chosen as optimal lens drive signal FOOₒₚₜᵢₘₐₗ.

An example for step 24 is then described below. The optical disc, LightScribe disc for example, comprises 400 spokes. When the optical disc is rotated a revolution, every spoke read by the optical pickup head also represents the spoke position of the optical disc passed by the optical pickup head. Therefore when every interrupt command is issued, the optical pickup head is passing its spoke position of the optical disc.

If the spoke position of the optical disc is represented as 1 to 400, the initial disc signal RFᵢₙᵢₜᵢₐₗ, the first disc signal RF_{first}, the second disc signal RF_{second} are compared at every spoke position of the optical disc in step 24. Assume at spoke position 100 of the optical disc, the initial disc signal RFᵢₙᵢₜᵢₐₗ is 120(DAC), the first disc signal RF_{first} is 125(DAC) and the second disc signal RF_{second} is 119(DAC). The first lens drive signal FOO_{first} which is corresponded to the first disc signal RF_{first} is chosen as the optimal lens drive signal FOOₒₚₜᵢₘₐₗ at the spoke position 100 of the optical disc. Therefore, the optical disc drive may acquire the optimal lens drive signal FOOₒₚₜᵢₘₐₗ at spoke positions 1 to 400 of the optical disc sequentially in a similar way. Refer to FIG. 3, wherein 33 is the optimal lens drive signal FOOₒₚₜᵢₘₐₗ which is slightly adjusted according to the above steps. The disc signal 34 under the optimal lens drive signal FOOₒₚₜᵢₘₐₗ 33 indeed has better performance than the initial disc signal RFᵢₙᵢₜᵢₐₗ 32. The optimal lens drive signal FOOₒₚₜᵢₘₐₗ has higher voltage level than the initial lens drive signal FOOᵢₙᵢₜᵢₐₗ at the spoke position 100 of the optical disc, while the optimal lens drive signal FOOₒₚₜᵢₘₐₗ has lower voltage level than the initial lens drive signal FOOᵢₙᵢₜᵢₐₗ at spoke position 360 of the optical disc. Therefore, the present invention adjusts the lens drive signal slightly at every spoke position of the optical disc to acquire the optimal lens drive signal FOOₒₚₜᵢₘₐₗ so that the focus accuracy of the optical pickup head is improved and a better printing quality of the LightScribe disc is then acquired.

It is to be noted that the above embodiment adopts RF signal as the disc signal. However, adopting sub-beam adder signal (SBAD) can also achieve the same effect of the above embodiment.

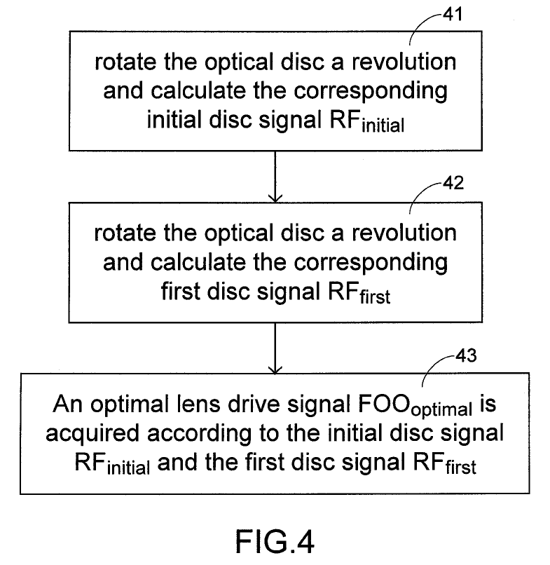

In addition, sometimes it is not necessary to proceed every step from step 21 to step 24 to improve focus accuracy of the optical pickup head. After trial and error, it is known that usually the optimal focus position of the optical pickup head shifts away from the optical disc, so only step 21, 23 and 24 are proceeded. The modified steps are shown in FIG. 4.

Step 41: rotate the optical disc a revolution and calculate the corresponding initial disc signal RFᵢₙᵢₜᵢₐₗ.

Step 42: rotate the optical disc a revolution and calculate the corresponding first disc signal RF_{first}.

Step 43: An optimal lens drive signal FOOₒₚₜᵢₘₐₗ is acquired according to the initial disc signal RFᵢₙᵢₜᵢₐₗ and the first disc signal RF_{first}.

The descriptions about step 41, 42 and 43 are thus omitted because they are similar to step 21, 23 and 24.

In another word, after trial and error, if it is known that usually the optimal focus position of the optical pickup head shifts near the optical disc, then only step 21, 22 and 24 are proceeded.

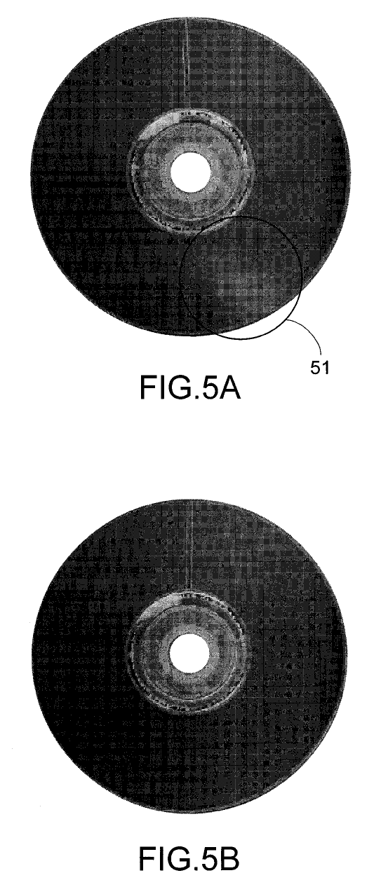

Moreover, refer to FIGS. 5A and 5B, which illustrates the printing quality of the LightScribe disc before and after adopting the present invention. In FIG. 5A, the printing quality of area 51 indeed shows some defects resulted from focus loss of the optical pickup head. However, the printing quality of the LightScribe disc is better by adopting the present invention to improve the focus accuracy as shown in FIG. 5B.

Thus, the virtue of the present invention is providing a firmware solution for overcoming the problem of focus loss resulted from NRRO phenomenon of spindle motor. The lens drive signal FOO and the corresponding disc signal RF are obtained when the optical disc is rotated a revolution, i.e. 400 interrupt commands are issued. The focus errors are estimated by means of RF signal so that the lens drive signal FOO is slightly adjusted to obtain the optimal lens drive signal FOOₒₚₜᵢₘₐₗ. The focus accuracy of the optical pickup head is thus effectively improved.

Another virtue of the present invention is effectively improving the problem of focus loss resulted from that the vibration of the optical disc drive which has frequency higher than 2θ cannot be compensated by the control chip of the optical disc drive. The present invention adjusts the lens drive signal at every spoke position of the optical disc, i.e. at each position of 400 spoke positions, to acquire the optimal lens drive signal. The adjustment is thus not limited to the frequency of the focus error. In theory, the focus error in any frequency can be convergent by the above way.

The third virtue of the present invention is rapidly adjusting the lens drive signal so that the focus accuracy of the optical pickup head is effectively improved. The optimal lens drive signal is acquired after the optical disk is rotated three revolutions by means of the present invention. Even the focus error is still high, the optimal lens drive signal can be rapidly acquired by the learning mechanism of the present invention. Thus the present may conform to the serious requirement for focus accuracy of the high speed optical disc drive.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for improving focus accuracy of an optical pickup head which is applied in the control process when an optical pickup head focuses on an optical disc, wherein the optical disc has a label side and a plurality of spokes are set up on the inner part of the label side, comprising:
rotating the optical disc a revolution and calculating a corresponding initial disc signal when the optical pickup head is driven by an initial lens drive signal;
rotating the optical disc a revolution and calculating a corresponding first disc signal when the optical pickup head is driven by an first lens drive signal; and
obtaining an optimal lens drive signal according the initial disc signal and the first disc signal.

2. The method for improving focus accuracy of an optical pickup head according to claim 1 further comprises the step of:
rotating the optical disc a revolution and calculating a corresponding second disc signal when the optical pickup head is driven by an second lens drive signal; and

3. The method for improving focus accuracy of an optical pickup head according to claim 2 wherein the optimal lens drive signal is further adjusted according to the second disc signal.

4. The method for improving focus accuracy of an optical pickup head according to claim 1 wherein the first lens drive signal is the summation of the initial lens drive signal and a first voltage and the first lens drive signal drives the lens moving near the optical disc.

5. The method for improving focus accuracy of an optical pickup head according to claim 2 wherein the second lens drive signal is the summation of the initial lens drive signal and a second voltage and the second lens drive signal drives the lens moving away from the optical disc.

6. The method for improving focus accuracy of an optical pickup head according to claim 1 wherein the first lens drive signal is the summation of the initial lens drive signal and a first voltage and the first lens drive signal drives the lens moving away from the optical disc.

7. The method for improving focus accuracy of an optical pickup head according to claim 2 wherein the second lens drive signal is the summation of the initial lens drive signal and a second voltage and the second lens drive signal drives the lens moving near the optical disc.

8. The method for improving focus accuracy of an optical pickup head according to claim 1 wherein these spokes are equally distributed on the inner part of the label side.

9. The method for improving focus accuracy of an optical pickup head according to claim 8 wherein the optical disc drive decodes these spokes and issues an interrupt command when every spoke is read.

10. The method for improving focus accuracy of an optical pickup head according to claim 9 wherein calculating the disc signal further comprises the step of recording the disc signal under the driven lens drive signal when the optical disc drive issues interrupt commands.

11. The method for improving focus accuracy of an optical pickup head according to claim 1 wherein the disc signal is the radio frequency signal (RF signal).

12. The method for improving focus accuracy of an optical pickup head according to claim 1 wherein the disc signal is the sub-beam adder signal (SBAD signal).
